(19) United States
(12) Patent Application Publication
(10) Pub. No.: US 2019/0392403 A1
(43) Pub. Date: Dec. 26, 2019

(54) COLLECTING AND SORTING GARBAGE AND MANAGING RECYCLING USING SENSING TECHNOLOGY

(71) Applicants: Antonio Alfredo Rainaldi, London (GB); Alberto Crivellaro, Milan (IT)

(72) Inventors: Antonio Alfredo Rainaldi, London (GB); Alberto Crivellaro, Milan (IT)

(21) Appl. No.: 16/442,291

(22) Filed: Jun. 14, 2019

Related U.S. Application Data
(60) Provisional application No. 62/689,029, filed on Jun. 22, 2018.
(60) Provisional application No. 62/788,362, filed on Jan. 4, 2019.

(51) Int. Cl. G06Q 10/00; G06F 16/23; G06Q 30/02

(52) U.S. Cl. CPC G06Q 10/30; G06F 16/2379; G06K 7/1413; G06Q 30/0215; G06F 16/2365

(57) ABSTRACT

Systems and methods for collecting and sorting garbage are described herein. The system may include a processing unit, a sensing unit, and a blockchain node. The processing unit may be configured to receive, from a user device associated with a user, an identifier associated with a garbage collection bin. The user device may be associated with user data. The processing unit may be further configured to collect garbage collection data from a sensing unit associated with the garbage collection bin. The processing unit may be further configured to assign a reward to the user for placing the garbage item into the garbage collection bin, based on the identifier, the user data, and the garbage collection data. The blockchain node may be configured to store the user data and data concerning the reward.

### CROSS-REFERENCE TO RELATED APPLICATIONS

This application claims priority of U.S. Provisional Patent Application No. 62/689,029 filed on Jun. 22, 2018, entitled “INTEGRATED SYSTEM FOR THE MANAGEMENT AND INCENTIVIZATION OF RECYCLING,” and U.S. Provisional Patent Application No. 62/788,362 filed on Jan. 4, 2019, entitled “SYSTEMS AND METHODS FOR COLLECTING AND SORTING GARBAGE USING SENSING TECHNOLOGY,” which are incorporated herein by reference in their entirety.

### TECHNICAL FIELD

The present disclosure relates generally to sensing technology and specifically to systems and methods for collecting and sorting garbage and managing recycling using sensing technology.

### BACKGROUND

Waste can be collected and sorted manually at home. Conventional waste collection methods include curbside collection schemes when designated personnel use specially built vehicles to collect household waste. Separate containers may be used by garbage disposal services for different types of waste.

Conventional methods of incentivizing people to sort waste properly into corresponding bins may include imposing a fine on people or neighborhoods for improper handling of the waste, increasing a fee for service if the waste is not sorted properly, providing monetary rewards for properly sorting the waste, and so forth. However, people may still see no or little reward for the efforts spent on collecting and sorting waste and be insufficiently motivated to handle their waste properly.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for collecting and sorting garbage. The technical effects of the present disclosure generally include incentivizing users to engage in virtuous garbage disposal. Specifically, users are incentivized to interact with the garbage collection bin by awarding them for properly discarding the waste in the garbage collection bins. Further technical effects include awarding users for proper sorting of waste, encouraging waste disposal in a virtuous manner, facilitating sorting, disposal, measuring, monitoring, and verifying different aspects of waste disposal by implementing a reward/punishment system.

In some example embodiments, a method for collecting and sorting garbage may commence with a processing unit receiving, from a user device associated with the user, an identifier associated with a garbage collection bin. The user device may be associated with user data. The method may further include sensing, by a sensing unit associated with the garbage collection bin, garbage collection data associated with the garbage collection bin. The garbage collection data may include at least data concerning placing a garbage item into the garbage collection bin by the user. The method may further include collecting, by the processing unit, the garbage collection data from the sensing unit. The method may further include assigning, based on the identifier, the user data, and the garbage collection data, a reward to the user for placing the garbage item into the garbage collection bin. The method may further include storing the user data and data concerning the reward to a blockchain node.

In some example embodiments, a system for collecting and sorting garbage may include a processing unit, a sensing unit, and a blockchain node. The processing unit may be configured to receive, from a user device associated with a user, an identifier associated with a garbage collection bin. The user device may be associated with user data. The processing unit may be further configured to collect the garbage collection data from a sensing unit associated with a garbage collection bin. The processing unit may be further configured to assign, based on the identifier, the user data, and the garbage collection data, a reward to the user for placing the garbage item into the garbage collection bin. The blockchain node may be configured to store the user data and data concerning the reward.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 illustrates an environment within which a system and methods for collecting and sorting garbage can be implemented, in accordance with some embodiments.

FIG. 2 is a block diagram showing an architecture of a garbage collection bin, according to an example embodiment.

FIG. 3 is a block diagram illustrating an exemplary architecture for providing communications between a garbage collection bin and a server, according to an example embodiment.

FIG. 4 is a block diagram showing various modules of a system for collecting and sorting garbage, in accordance with certain embodiments.

FIG. 5 is a flow chart illustrating a method for collecting and sorting garbage, in accordance with an example embodiment.

FIG. 6 is a schematic diagram showing user interfaces of an application running on a user device, according to an example embodiment.

FIG. 7 is a schematic diagram showing user interfaces related to management of a wallet associated with an application running on a user device, according to an example embodiment.

FIG. 8 is a schematic diagram showing user interfaces related to management of garbage collection bins, according to an example embodiment

FIG. 9 is a schematic diagram showing user interfaces associated with an application running on a user device, according to an example embodiment.

FIG. 10 is a schematic diagram showing user interfaces representing a services page associated with an application running on a user device, according to an example embodiment.

FIG. 11 illustrates an environment within which methods and systems for collecting and sorting garbage can be implemented, according to an example embodiment.

FIG. 12 is a flow diagram showing steps of a method for collecting and sorting garbage, according to an example embodiment.

FIG. 13 is a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides methods and systems for collecting and sorting garbage based on sensing technology. These methods and systems may be used for management of urban waste and valorization of waste disposal through a currency allocation (e.g., cryptocurrency) for recycling waste by citizens. Specifically, the methods and systems may be used for improving efficiency of garbage disposal, collection, sorting, and traceability, as well as for inferring information about behavior of users and prompting the users to engage in virtuous garbage disposal.

The system of the present disclosure may monitor collection of trash. In an example embodiment, the system for collecting and sorting garbage may include a garbage collection bin. The garbage collection bin may include, for example, a receptacle and a lid for covering the receptacle, and may further include a sensor unit for recording garbage collection data. The sensor unit may be mounted on the lid or any other part of the garbage collection bin. The sensor unit may include one or more sensors, such as a fill level senor or a material proximity sensor, which may be configured to sense garbage collection data. The garbage collection data may include data concerning placing a garbage item into the garbage collection bin by a user. The sensor unit may further have a microcontroller for collecting the garbage collection data from the sensors and communicating the collected garbage collection data to a server. The server may include a processing unit for collecting and processing the garbage collection data. The server may gather all the information about devices associated with the system, such as a state of a garbage collection bin, a battery level, a fill level of the garbage collection bin, and the number of items disposed in the garbage collection bin; and provide alerts whenever a non-identified item is inserted into the garbage collection bin and/or whenever the garbage collection bin is full and should be emptied.

The system of the present disclosure may further be associated with an application running on a user device associated with the user. The user may install the application to utilize the application for receiving a reward for interacting with the garbage collection bin properly when disposing waste into the garbage collection bin. Specifically, the garbage collection bin may include an identifier, such as a Quick Response (QR) code, disposed on the garbage collection bin. The user may scan the identifier using the application running on the user device. The application may read the identifier and send the identifier to the processing unit of the server. Upon receipt of the identifier from the user, the processing unit may determine that the user is in a proximity of the garbage collection bin and is planning to discard waste.

The application may also provide user data, such as login information, wallet information, and the like, to the processing unit of the server. Based on the identifier and the user data received from the user device and based on the garbage collection data received from the sensing unit of the garbage collection bin, the processing unit may ascertain that the user discarded the waste into the garbage collection bin. Based on the ascertaining, the processing unit may assign a reward to the user for placing the garbage item into the garbage collection bin. In an example embodiment, the reward may be provided in the form of cryptocurrency transferred to a wallet of the user.

The system may further include a blockchain unit. All information collected by the system, information associated with the wallet of the user, and information concerning cryptocurrency transactions made by the user may be stored in the blockchain unit.

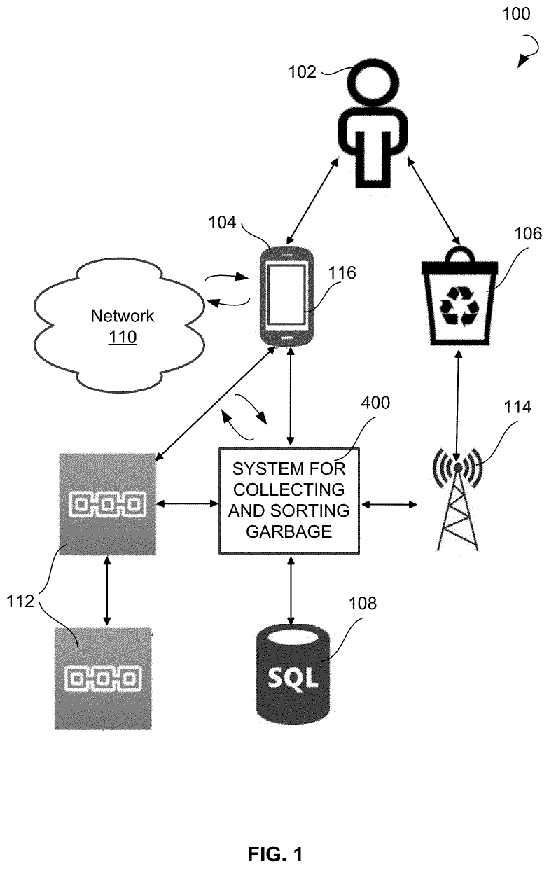

Referring now to the drawings, FIG. 1 illustrates an environment 100 within which methods and systems for collecting and sorting garbage can be implemented. The environment 100 may include a data network 110, a user 102, a user device 104 associated with the user 102, a garbage collection bin 106, a system 400 for collecting and sorting garbage (also referred to as a system 400), a database 108, a blockchain unit 112, and a low-power network 114. The user device 104 may include a smartphone, a tablet personal computer (PC), a personal wearable device, a computing device, and so forth. An application 116 associated with the system 400 may be running on the user device 104.

The data network 110 may include the Internet, a computing cloud, Representational State Transfer services cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network may include a network of data processing nodes, also referred to as network nodes, that are interconnected for the purpose of data communication.

The garbage collection bin 106 may be a physical device that allows the user 102 to collect waste. The garbage collection bin 106 may connect to the rest of components of the system 400 through the low-power network 114 configured to connect low-power objects, such as smartwatches and electricity meters, which need to be continuously on and emitting small amounts of data. The low-power network 114 may include, e.g., the Sigfox network.

The garbage collection bin 106 may be associated with an identifier, e.g., a QR code printed on the garbage collection bin 106 itself. Specifically, the user 102 may use the user device 104 to scan the QR code printed on the garbage collection bin 106. Upon scanning, the user device 104 may send the identifier to the system 400. Upon scanning the identifier, the user 102 may put the waste in the garbage collection bin 106. The garbage collection bin 106 may have sensors to identify the fact of placing the waste in the garbage collection bin 106. The garbage collection bin 106 may send garbage collection data to the system 400. The system 400 may receive the identifier from the user device 104 and receive the garbage collection data from the garbage collection bin 106 and determine, based on the received data, that the user 102 has properly discarded the waste to the garbage collection bin 106. The system 400 may reward the user 102 for placing the garbage item into the garbage collection bin.

The system 400 may have the database 108. The system 400 may store user data of the user 102, application data, data concerning the garbage collection bin 106, garbage collection data, and the like to the database 108.

The system 400 may be associated with the blockchain nodes 112. The blockchain nodes 112 may keep track of a wallet of the user 102 to which the reward may be provided and manage all blockchain transactions.

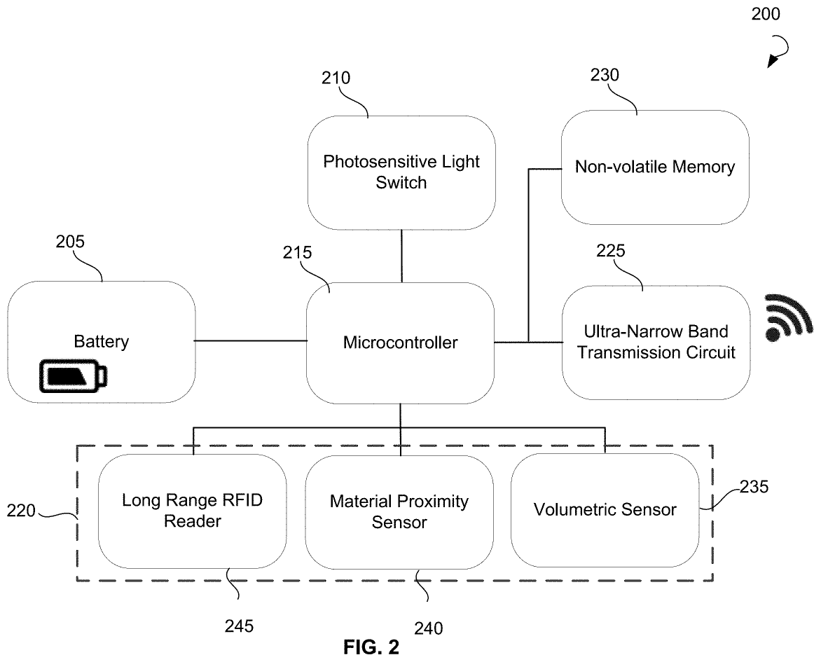

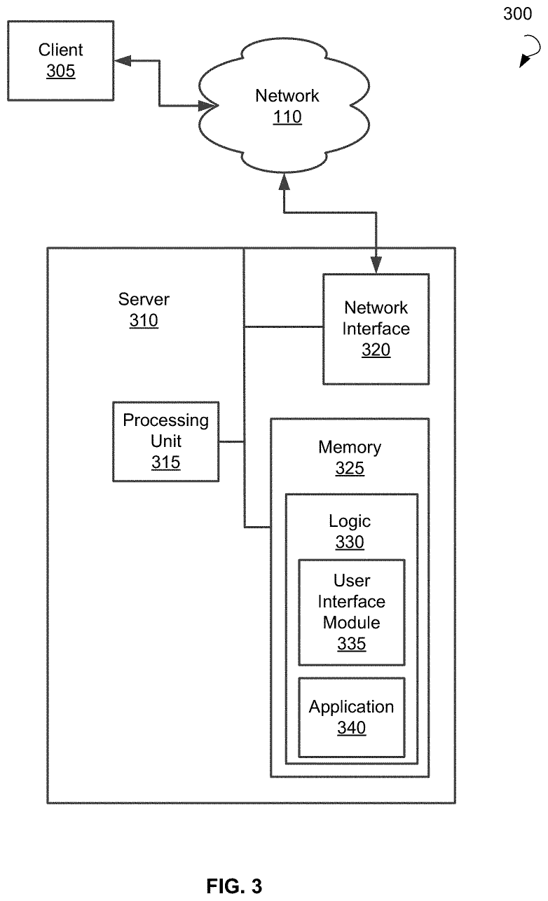

FIG. 2 is a block diagram showing an architecture 200 of a garbage collection bin, according to an example embodiment. FIG. 2 shows the main functional blocks of the garbage collection bin. The garbage collection bin may be powered by a battery 205. The battery 205 may be an interchangeable battery including a photosensitive light switch 210. The garbage collection bin may further have a microcontroller 215. The microcontroller 215 may monitor the signals received by sensors 220 and transmit the sensed data to a remote server through an ultra-narrow band transmission circuit 225. The collected data may be also saved to a non-volatile memory 230. In various embodiments, the sensors 220 may include one or more sensors connected to the garbage collection bin to allow adaption of the garbage collection bin to the different applications and in different configurations. For example, a volumetric sensor 235 may be attached to the garbage collection to monitor the fill level of the garbage collection bin. The garbage collection bin may be further equipped with a material proximity sensor 240 sensitive to different ferrous and non-ferrous materials. In an example embodiment, the garbage collection bin may be equipped with a long-range Radio-Frequency Identification (RFID) reader 245. The architecture 200 shown on FIG. 2 may be referred herein to as a client 305 shown on FIG. 3.

FIG. 3 is a block diagram illustrating an exemplary architecture 300 for providing communications between a garbage collection bin shown as a client 305 and a server 310. Both the client 305 and the server 310 may be components of the system 400 for collecting and sorting garbage. The server 310 may be configured to provide various functionalities, which are described in greater detail herein. Generally, the server 310 may be configured to communicate with client devices, such as the client 305. The client 305 may include, for example, a sensor unit of the garbage collection bin, the architecture 200 of which is shown on FIG. 2. The server 310 may communicatively couple with the client 305 via a public or private network, such as a network 110 described with reference to FIG. 1.

The server 305 may include a processing unit 315, a network interface 320, and a memory 325. The memory 325 may include logic 330 (e.g., instructions) that can be executed by the processing unit 315 to perform various operations. The logic 330 may include a user interface module 335 and a data aggregation and correlation application hereinafter referred to as an application 340 for facilitating sensing and tracking of trash collection.

In an example embodiment, the server 310 and the application 340 may also be executed within the client 305. Specifically, the client 305 may be programmed to execute the functionalities of the server 310 and the application 340. In other example embodiments, the server 310 and client 305 may cooperate to provide the functionalities described herein. Specifically, the client 305 may be provided with a client-side application that may interact with the server 310 such that the server 310 and client 305 may operate in a client/server relationship. Complex computational features may be executed by the server 310, while simple operations that require fewer computational resources may be executed by the client 305, such as data gathering and data display.

In an example embodiment, the application 340 may also be installed on a user device and may communicate with the server 310.

In various example embodiments, the garbage collection bin shown as the client 305 may be used for various purposes (for example, a coffee machine with coffee pod collection capability, a coffee pod collection device, a waste deposit device, and so forth). In an example embodiment, the garbage collection bin may be used for collecting batteries from users, such as batteries of electric cars. The collected batteries may be provided to an appropriate party for recycling or converting into other items, such as power units. The user may receive a reward for discarding a used battery pack.

In a further example embodiment, the server 310 may communicate with a plurality of garbage collection bins through a network (e.g., the data network 110). For example, the server 310 may act as a central server and may communicate with both garbage collection bins and user devices on which the application 340 is installed.

In a further example embodiment, the system 400 may communicate with smart home intelligent systems, including but not limited to Alexa by Amazon, Google Home, and the like.

In an example embodiment, the client 305 may be manually registered to the network, such as the Sigfox network, and may send data when a state change of the garbage collection bin is detected or upon events. Data may be pushed to the server 310 through a POST callback request via the Sigfox network. The POST request typically requests that a server accepts the data enclosed in the body of the request message (most likely for storing it).

The data sent by the client 305 may include information about one or more of the following: an identification (ID) of the garbage collection bin, location, fill level, new capsule/new unknown item introduced (in case the garbage collection bin is a coffee pod collection device), ID of a bag introduced (in case the garbage collection bin is a waste deposit device), information concerning status of the garbage collection bin, and the like. The server 310 may compare information coming from the user devices when users scan QR codes on the garbage collection bins and information sent by the sensing units of the garbage collection bins. Based on the received information, the server 305 may implement reward logics and checks, plan trash disposal and technical interventions, and so forth.

In an embodiment when the garbage collection bin is a coffee pod collection device, the garbage collection bin may be used for collecting coffee pods. The coffee pod collection device may include a bin (e.g., having a size of about or less than 15 inches) that collects coffee capsules of a selected brand/model. The coffee pod collection device may be equipped with a battery pack and a microcontroller communicating with the server 310 as described above. The components of the coffee pod collection device may be mounted inside a lid of the coffee pod collection device. The coffee pod collection device may be further equipped with the following components: a fill level sensor, a material-sensitive sensor, a photo-sensitive switch on a circuit (or a mechanical switch), status Light-Emitting Diodes (LEDs) visible on the coffee pod collection device, a shape template on the lid, trash dumpster specifications, and a label with a QR code to be scanned by users.

The coffee pod collection device may further include a sensing unit to sense the status of the trash deposit and communicate with the server 310. The coffee pod collection device (and its power unit) may be enclosed in an IP65 case (International Protection Marking showing dust and water resistance). The case may be fixed inside the lid of the coffee pod collection device.

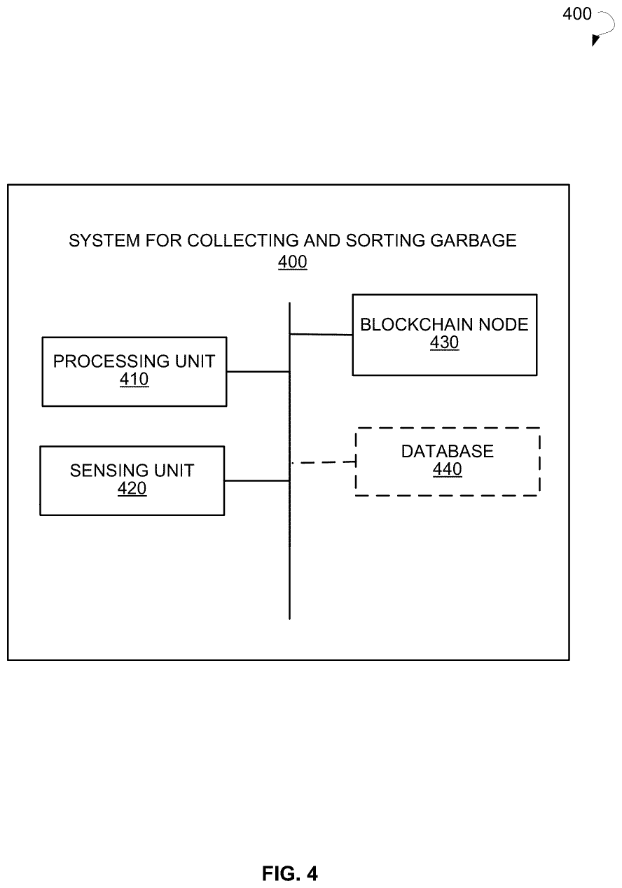

FIG. 4 is a block diagram showing various modules of a system 400 for collecting and sorting garbage, in accordance with certain embodiments. Specifically, the system 400 may include a processing unit 410, a sensing unit 420 associated with a garbage collection bin, a blockchain node 430, and optionally a database 440. In an example embodiment, each of the processing unit 410 and the sensing unit 420 may include a programmable processor, such as a microcontroller, a central processing unit, and so forth. In example embodiments, each of the processing unit 410 and the sensing unit 420 may include an application-specific integrated circuit or programmable logic array designed to implement the functions performed by the system 300.

The sensing unit 420 may be configured to sense garbage collection data associated with the garbage collection bin. The garbage collection data may include at least data concerning placing a garbage item into the garbage collection bin by a user. In an example embodiment, the sensing unit 420 may include one or more sensors to sense the garbage collection data. The one or more sensors may include one or more of the following: a garbage fill level sensor, a material proximity sensor, a status light-emitting diode, a camera, and the like. For example, the status light-emitting diode may be visible on a lid of the garbage collection bin and may reflect a fill level of the garbage collection bin using the garbage fill level senor. The sensing unit 420 may further include a microcontroller in communication with the one or more sensors. The microcontroller may be configured to transmit the garbage collection data to the processing unit via a transmission circuit. The sensing unit 420 may further include a power source in communication with the one or more sensors and the microcontroller.

The sensing unit 420 may be further configured to verify compliance of the garbage item placed into the garbage collection bin with predetermined criteria. For example, the lid of the garbage collection bin may be provided in a shape of a coffee pod. The sensing unit 420 may have sensors to verify compliance of items inserted through the lid with the predetermined criteria. In this case, the garbage collection data transmitted by the sensing unit 420 to the processing unit may further include data concerning compliance of the garbage item.

The processing unit 410 may be configured to receive, from a user device associated with the user, an identifier associated with the garbage collection bin. The user device may be associated with user data. The identifier may be scannable by the user device from the garbage collection bin. The processing unit 410 may be configured to collect, from the sensing unit 420, the garbage collection data. The processing unit 410 may be configured to assign a reward to the user for placing the garbage item into the garbage collection bin. The reward may be selected and assigned based on the identifier received from the user device, the user data, and the garbage collection data received from the sensing unit 420. In an example embodiment, the assigning of the reward may include providing cryptocurrency to a wallet of the user.

The processing unit 410 may be further configured to provide a report to a garbage managing party. The processing unit 410 may generate the report based on the garbage collection data. The report may include one or more of the following: an instruction to empty the garbage collection bin, a report on types of items placed in the garbage collection bin, a report on a status of the garbage collection bin, and so forth.

In an example embodiment, the sensing unit 420 may be further configured to detect a tag placed on a further garbage item present in the garbage collection bin. The sensing unit 420 may scan the tag and send the scanned tag to the processing unit 410. In an example embodiment, the tag may include one or more of the following: a barcode label, an RFID tag, a smart label, and the like.

The processing unit 410 may be configured to receive tag data associated with the tag from the sensing unit 420. The tag data may be retrieved from the tag based on the scanning performed by the sensing unit 420. The processing unit 410 may determine that the tag data are associated with the user data. Based on the determination, the processing unit 410 may ascertain that the further garbage item is placed in the garbage collection bin by the user.

The blockchain node 430 may be configured to store the user data, data concerning the reward, and all transactions associated with the cryptocurrency.

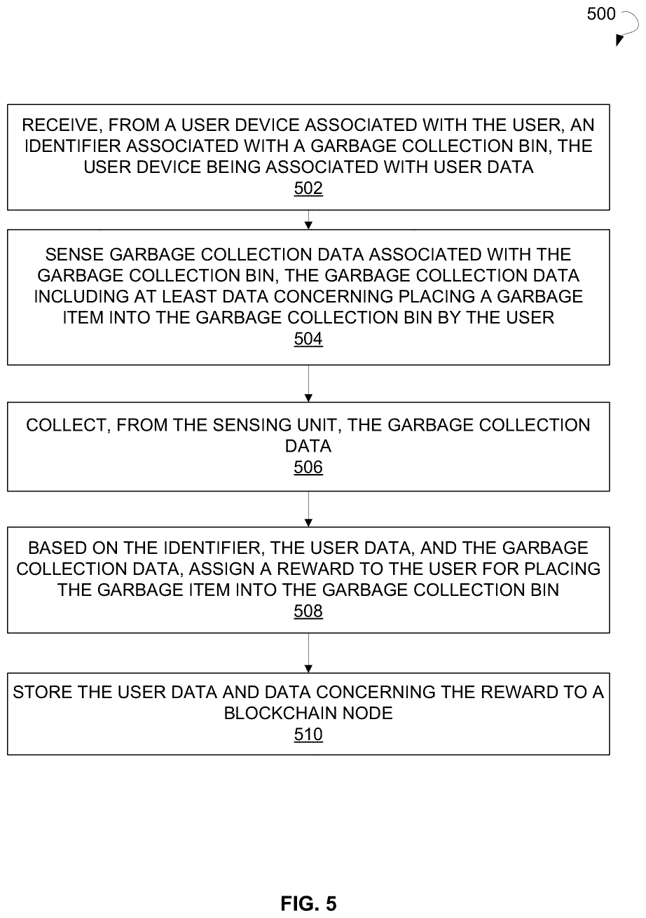

FIG. 5 is a flow chart illustrating a method 500 for collecting and sorting garbage, in accordance with certain embodiments. In some embodiments, the operations may be combined, performed in parallel, or performed in a different order. The method 500 may also include additional or fewer operations than those illustrated. The method 500 may be performed by processing logic that may comprise hardware (e.g., decision making logic, dedicated logic, programmable logic, and microcode), software (such as software run on a general-purpose computer system or a dedicated machine), or a combination of both.

The method 500 may commence with receiving, from a user device associated with the user, an identifier associated with a garbage collection bin at operation 502. The user device may be associated with user data. The identifier may be placed on the garbage collection bin and may be scannable by the user device. In an example embodiment, the identifier may include a code, such as a QR code, a linear barcode, a two-dimensional barcode, and so forth.

The method 500 may continue with sensing garbage collection data associated with the garbage collection bin at operation 504. The sensing may be performed by a sensing unit associated with the garbage collection bin. The garbage collection data may include at least data concerning placing a garbage item into the garbage collection bin by the user. The garbage collection data may further include a garbage fill level, ferrous material proximity data, non-ferrous material proximity data, a status of the garbage collection bin, and so forth.

The method 300 may further include collecting, by the processing unit, from the sensing unit, the garbage collection data at operation 506. Based on the identifier, the user data, and the garbage collection data, a reward for placing the garbage item into the garbage collection bin may be assigned to the user by the processing unit at operation 508. The reward may be assigned to the user by providing cryptocurrency to a wallet of the user. The method 500 may further include receiving, from the user device, a request to redeem the reward. Based on the request, one or more services or one or more products may be provided to the user in exchange for the cryptocurrency.

At operation 510, the processing unit may store the user data, data concerning the reward, and data related to all transactions associated with the cryptocurrency to a blockchain node.

The method 500 may further optionally include providing a report to a garbage managing party. The report may be generated based on the garbage collection data and may include one or more of the following: an instruction to empty the garbage collection bin, a report on types of garbage items placed in the garbage collection bin, a report on the status of the garbage collection bin, and so forth.

In an example embodiment, the method 500 may further include detecting, by the sensing unit, a tag placed on a further garbage item present in the garbage collection bin. The tag may include one or more of the following: a barcode label, an RFID tag, a smart label, and the like. The sensing unit may scan the tag. The method 500 may continue with receiving, by the processing unit, tag data associated with the tag from the sensing unit. The tag data may be retrieved from the tag based on the scanning. The method 500 may include determining, by the processing unit, that the tag data are associated with the user data. The tag may be preliminarily provided to the user for placing on garbage items. The processing unit may ascertain that the further garbage item is placed in the garbage collection bin by the user and assign a further reward to the user based on the fact of placing the further garbage item to the garbage collection bin by the user.

In an example embodiment, the method 500 may further include verifying, by the sensing unit, compliance of the garbage item placed into the garbage collection bin with predetermined criteria. The garbage collection data transmitted by the sensing unit to the processing unit may further include data concerning compliance of the garbage item.

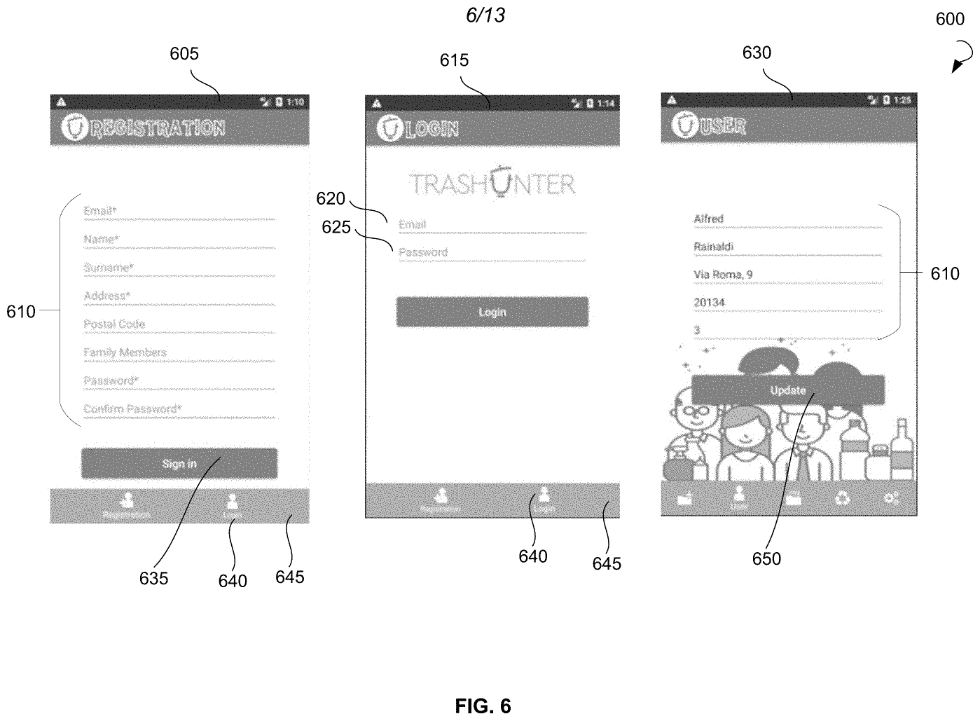

FIG. 6 is a schematic diagram 600 showing user interfaces of an application running on a user device, according to an example embodiment. The application may be installed on the user device and may communicate with a server 310 shown on FIG. 3. Upon being installed on the user device, the application may enable registering a user of the user device in the application. The registration in the application may be necessary to use the system 400 shown on FIG. 4. The registration may be done once for every user.

A user interface 605 shows a registration form, which the user needs to fill in to create a user account associated with the application. The user may need to enter user data 610, such as an email, name, surname, address, postal code, family members, password, confirm password, and the like. Some fields may be mandatory and some fields may be optional in the registration form. The user data 610 may be stored in a database 440 of the system 400 as shown on FIG. 4.

A tap on the “sign in” button 635 may trigger creation of a user profile by saving the information in the database 440. If the registration is successful, a confirmation popup message may appear on the user interface 605; otherwise the popup message may contain an error message. After a successful registration, the user may proceed to login.

A tap on the “login” button 640 in a navigation bar 645 may open a login page shown as a user interface 615. The user may need to fill in the login page to enter the application upon the registration process. The user may be asked to enter the email 620 and the password 625 used during the registration.

A user interface 630 visualizes user account data and enables user account data management. Specifically, the user may update the user data 610 using the user interface 630. The user interface 630 may show the name, surname, address, postal code, family members, and so forth. The user may edit the information directly in a form shown on the user interface 630. To save the data, the user may tap an “update” button 650.

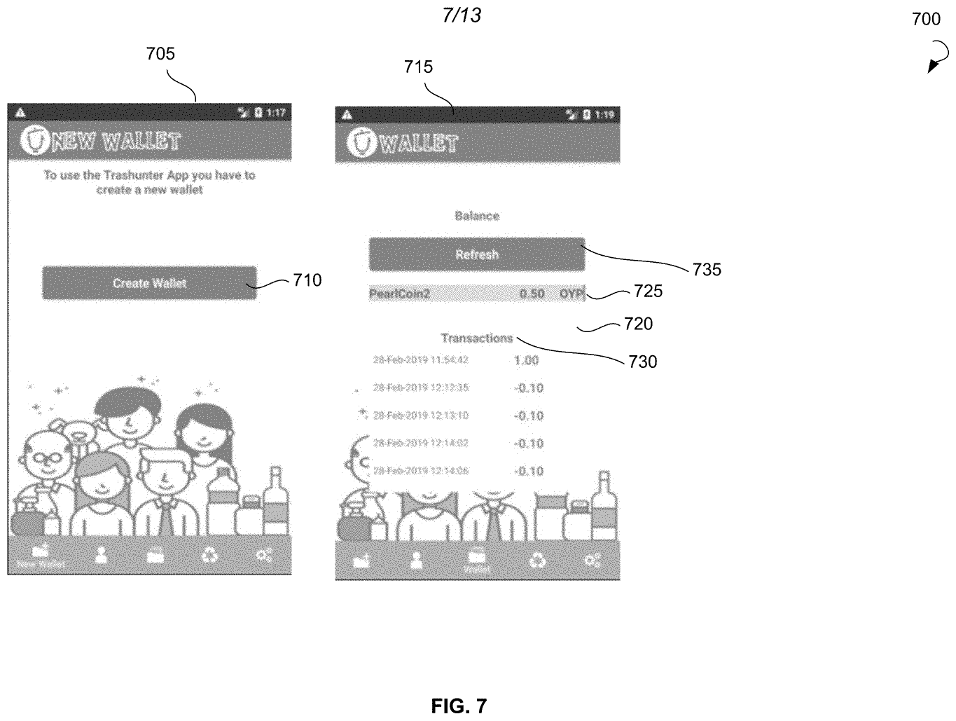

FIG. 7 is a schematic diagram 700 showing user interfaces related to management of a wallet associated with the application running on the user device, according to an example embodiment. A user interface 705 may be shown to the user for creating the wallet. For example, after the first login, the user may create the wallet. Upon tapping on a “create wallet” button 710, a public key may be generated and stored in the database 440 and on the blockchain node 430 of the system 400 shown on FIG. 4. The public key may be used to receive payments. The generation of the user public key may be performed as follows. Firstly, a wallet address and the application key pair (private and public key) may be generated. The private key may be stored in the user device. The wallet address and the public key may be communicated to the database 440 and the blockchain node 430. Then, the user may receive the authorization to act on the blockchain node 430.

In an example embodiment, tapping again on the “create wallet” button 710 may create a new wallet, thus losing all the cryptocurrency and the transactions eventually saved in the previous wallet.

A user interface 715 shows visualization of the wallet of the user on a wallet page 720. Once the wallet has been created, the wallet page 720 may show wallet information. The wallet information may include a wallet balance showing the total balance 725 of the cryptocurrency of the user. The wallet information may further include information concerning transactions 730, such as a list of outgoing and incoming transactions. A row for every transaction may include date, time, and value related to the transaction. A tap on the “refresh” button 735 may update a list of the transactions 730.

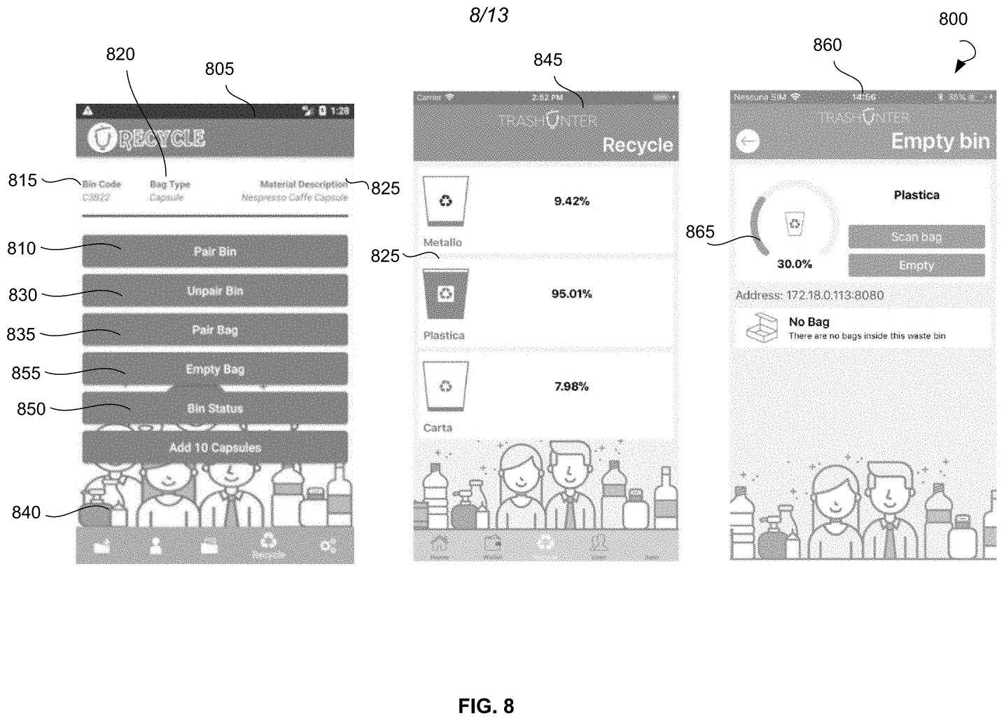

FIG. 8 is a schematic diagram 800 showing user interfaces related to management of garbage collection bins, also referred herein to as bins, according to an example embodiment. As shown on a user interface 805, at a first step, the user may use the user device to pair the bin with the application. Specifically, the application may need to be paired with the bin before the user places a garbage item into the bin. The bin may be paired by scanning a QR code placed on the bin. A tap on the “pair bin” button 810 may activate a scanner on the user device. Once connected, the bin and the application may automatically interact and exchange information. Once paired, a bin code 815 associated with the bin may be visible on the user interface 805. The user interface 805 may also show a bag type 820 and a material description 825. The bag type 820 may identify types of bags that are allowable to be placed into the bin. The bag type 820 may include, for example, a capsule. The material description 825 may describe the materials placed into the bin. A tap on the “unpair bin” button 830 may unpair the bin from the application. This action may delete any information related to the bin from the application.

Once the bin has been paired with the application, the user can pair the bin with a waste bag (also referred to herein as a bag). Specifically, a plurality of tags, e.g., in the form of tagged stickers, may be preliminarily provided to the user. Each tag on the tagged stickers may be associated with the user data. The user may place the tag on a garbage item. For example, the user may place the tagged sticker onto the waste bag. The bag can be paired with the application by identifying the tag present on the bag itself. In an example embodiment, the tag may be provided in the form of a QR code, an RFID tag, and the like. The application may receive the scanned code. The code may also contain data concerning a volume capacity of the bag. The scanner can be activated on the user device by tapping the “pair bag” button 835 in the bin/bag panel page 840. Additionally, the sensor unit of the garbage collection bin may have sensors to detect and scan tags placed on items inserted into the garbage collection bin.

Once the bag has been paired with the bin, the bin/bag panel page 840 may show the information about the bag on a user interface 845. The information about the bag may include a bag type, a material description, a filling level percentage of the bin, a full bin alert, a notification indicating that the bin should be emptied, and the like.

A user interface 860 shows information of the bin. The filling level percentage 865 may be presented as a gray bar that becomes colored according to the filling percentage received from the bin. In case of unpairing the bin, the bag may be automatically unpaired from the application if the bag was paired to the bin. In this case, all the information about any garbage items in the bag may be lost. A tap on the “bin status” button 850 may update the fill level data of the bin by requesting information from the bin.

A user interface 860 shows data concerning collecting and sorting garbage by the user. Specifically, the user interface 860 may show a list 825 of bins. The list 865 of bins may show a level of filling (in percent) of the bins of the list 865 to notify the user whether any of the bins is full.

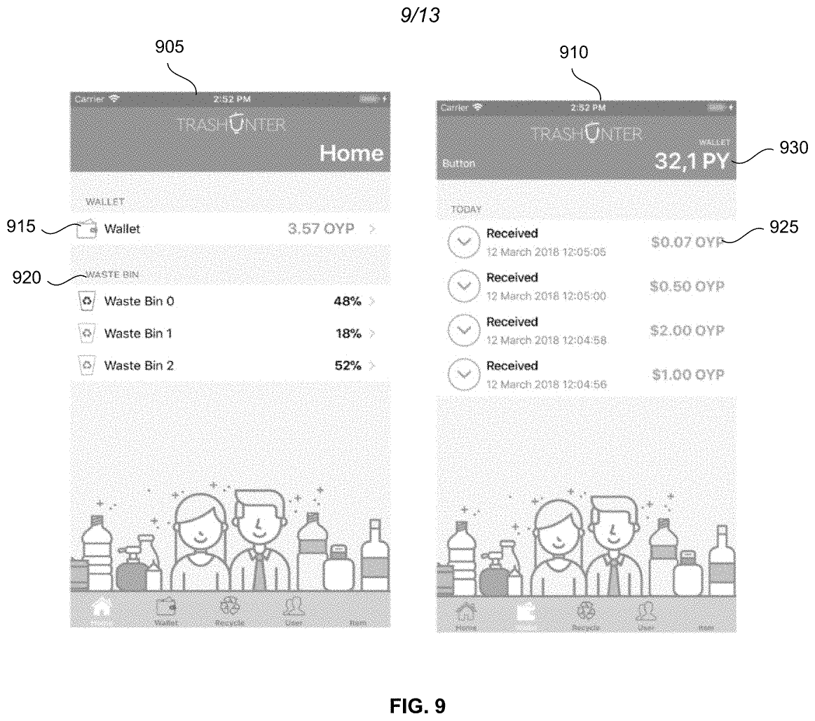

FIG. 9 shows further user interfaces 905 and 910 associated with the application. To get the payment in cryptocurrency for the content of the bag, the user need to remove the bag from the bin. This may be done by unpairing the bag from the bin. A tap on the “empty bag” button 855 shown on the user interface 805 in FIG. 8 may check the content of the bag (e.g., by using a materials proximity sensor for scanning metals or other materials) and send a corresponding amount of cryptocurrency to the wallet of the user. This transaction may be visible in the list of transactions in the wallet. The user interface 905 shows an amount of cryptocurrency in the wallet 915 and a list 920 of bins. The user interface 910 may show the amount 925 of cryptocurrency received for emptying the bags and a total amount 930 of cryptocurrency in the wallet.

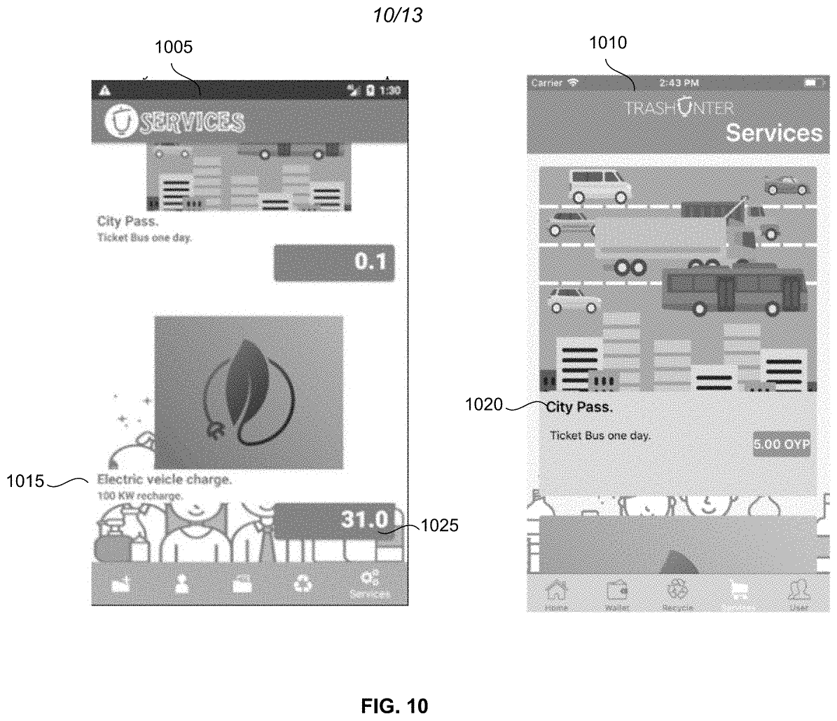

FIG. 10 shows user interfaces 1005 and 1010 representing a services page associated with the application running on the user device, according to an example embodiment. The user may use the services page to purchase a service or a product from a list of partners participating in providing services and/or products via the application. The services page may show a list of services and/or products. The user may select a product or a service from the list. The services and/or products may include an electric vehicle charge 1015 shown on the user interface 1005, a city pass 1020 shown on the user interface 1010, and so forth. The service may be represented by showing a picture, a name, a description, and a price of the service. To buy the service, the user may need to tap on the price 1025 of the service. If the purchase is confirmed, the balance in the wallet page may be updated and the transaction may be visible in the transaction list in the wallet page and through the corresponding blockchain monitor.

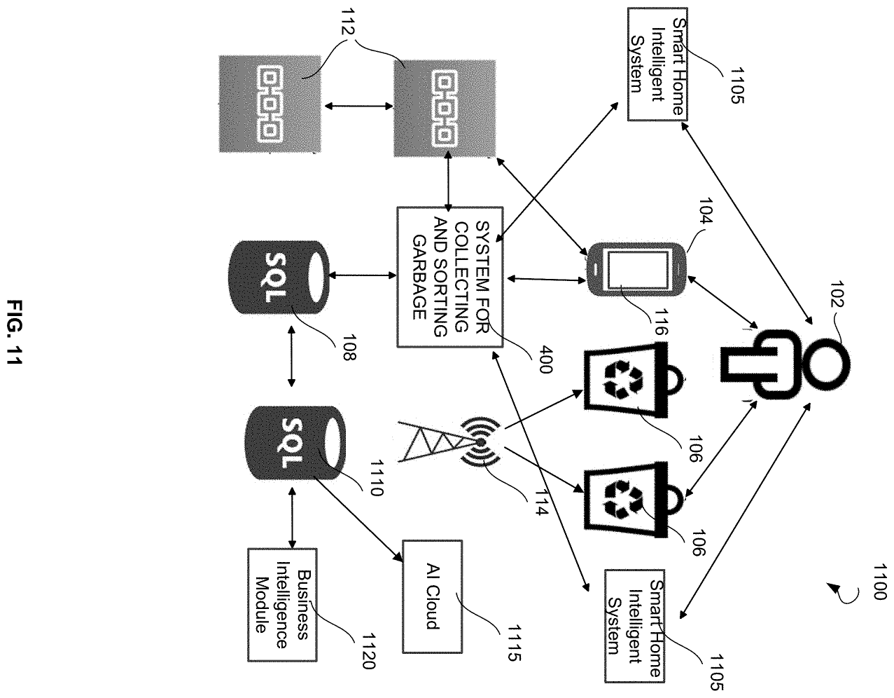

FIG. 11 illustrates an environment 1100 within which methods and systems for collecting and sorting garbage can be implemented, according to an example embodiment. Every user 102 may be able to use many different bins 106, even temporarily, and every bin 106 may be used by different users 102, one at a time. This may add flexibility to the system 400 so that the user 102 may be able to get credit for good habits of the user 102 in waste management, even when the bin 106 is not located in a house of the user 102.

The system 400 may manage many further products, thereby allowing for a greater enrollment of users and service and product producers. The system 400 may connect to other systems, such as smart home intelligent systems 1105, smart TV, smart home assistants (e.g., Alexa by Amazon, Google Home), and so on. This may provide the user 102 with a more immersive feedback in respect to garbage collection and sorting. The user 102 may also have different ways to interact with the feedback received from smart devices. For example, Alexa may suggest that since the user 102 has put in the bin the ninth package of a ten-capsule coffee package, the user 102 may need to buy a new pack of coffee. The report and/or a reminder to buy the coffee may be provided to the user 102.

The data collected by the system 400 may be useful to better understand and guide the life cycle of the managed products. The data may be duplicated from the database 108 to a clone database 1110. This approach may help improving the structure and the marketing of the system 400, further reducing waste of money and materials. The clone database 1110 may provide the collected data to an Artificial Intelligence (AI) cloud 1115 and a business intelligence module 1120. Specifically, geo-referenced statistics on the type and quantity of materials and products thrown away collected by the AI cloud 1115 and the business intelligence module 1120 can be a source of information for service providers and product producers.

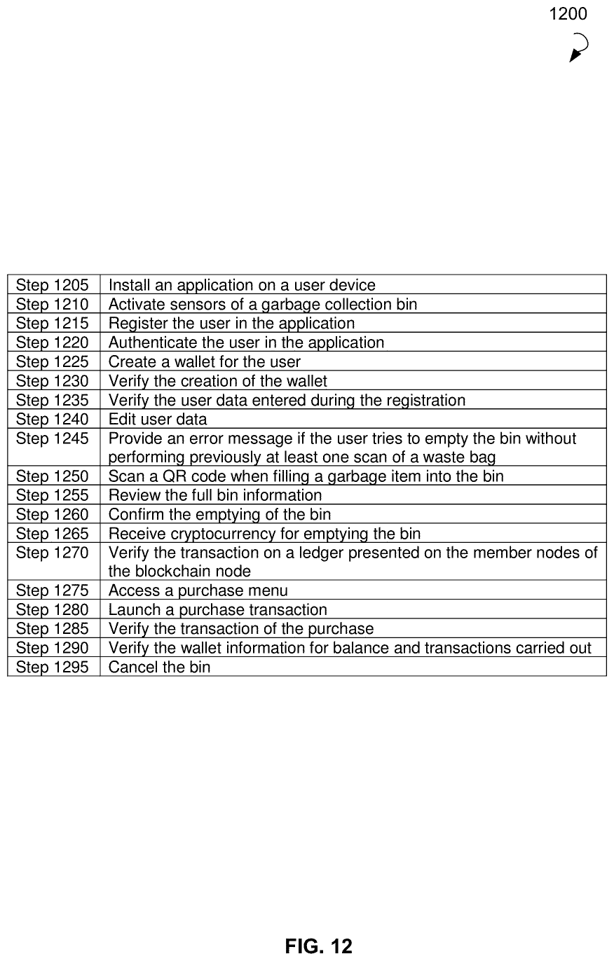

FIG. 12 is a flow diagram 1200 showing steps of a method for collecting and sorting garbage, according to an example embodiment. At step 1205, an application associated with the method for collecting and sorting garbage may be installed on a user device. At step 1210, a garbage collection bin having a sensing unit may be activated by connecting the sensing unit to a data network. The application may be configured to communicate with the sensing unit of the garbage collection bin. Each sensor of the sensor unit may have an Internet Protocol (IP) address and a port number. The application may communicate with the sensors based on the IP address and port number of the sensors.

At step 1215, the user may register in the application. The user may enter the user data required by the application and press a “sign in” button. The user data may be sent to a central server associated with a system for collecting and sorting garbage and saved in a database (e.g., in a cloud). At step 1220, the user may be authenticated in the application. The application may access the system to authenticate itself to the system and verify the credentials entered by the user. At step 1225, a wallet may be created for the user. Specifically, after the authentication, the application may automatically ask the user to create a wallet. To create the wallet, public and private keys may be generated. The private key remains known only to the user device that created the wallet. Only the public key is communicated to the blockchain node in order to receive the permissions to interact with the blockchain node. At step 1230, the creation of the wallet may be verified in the blockchain node. To verify transactions and their contents, a ledger shared between the blockchain nodes may be accessed.

At step 1235, the user data entered during the registration may be verified. The user data entered during the registration may be accessed via a navigation menu of the application. At step 1240, the user may edit the user data, if necessary. The edited user data can be saved by sending the user data to the database.

At step 1245, an error message may be provided by the application if the user tries to empty the bin without previously performing at least one scan of a waste bag. More specifically, if the user presses the “empty bin” button without putting any waste bag inside the bin, the application may provide the error message.

At step 1245, the user may scan a QR code of the waste bag when filling the waste bag into the bin. The QR code on the waste bag may contain information concerning a material placed into the waste bag (e.g., a plastic, a metal, glass) and the capacity (volume in liters) of the waste bag.

At step 1250, the user may review the bin information if the bin is full. At step 1260, the user may confirm the emptying of the bin. The user may empty the bin by accessing the details of the bin and pressing the “empty bin” button. This action may trigger a cryptocurrency request sent by the application to the system.

At step 1265, the user may receive cryptocurrency for emptying the bin. The user may access the wallet and review the balance of the wallet. At step 1270, the transaction may be verified on the ledger presented on member nodes of the blockchain node.

At step 1275, the user may access a purchase menu of the application, where a list of possible purchases may be available. At step 1280, a purchase transaction may be launched. Specifically, the purchase may be confirmed by the user. If the user has the corresponding amount of cryptocurrency, a purchase transaction may be triggered and the identifier of the transaction on the blockchain node may be confirmed and indicated or, if not confirmed, a message may indicate the insufficiency of the cryptocurrency. At step 1285, the purchase transaction may be verified by accessing the ledger of the blockchain node.

At step 1290, the user may verify the transaction of the purchase and may access the wallet to verify that the wallet has been updated with the last transaction carried out.

At step 1295, the user may cancel the bin by selecting the bin and dragging the bin to the side of the user interface. The deletion of the bin may cancel the data relating to any scanned waste bags.

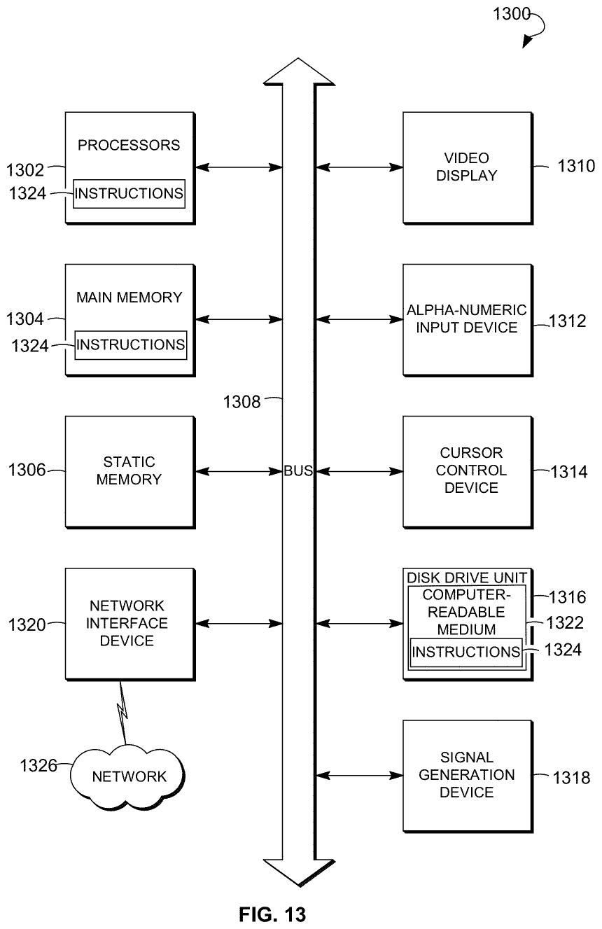

FIG. 13 shows a diagrammatic representation of a machine in the example electronic form of a computer system 1300, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a smart phone, a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor or multiple processors 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 may also include an alphanumeric input device 1312 (e.g., a keyboard), a cursor control device 1314 (e.g., a mouse), a disk drive unit 1316, a signal generation device 1318 (e.g., a speaker), and a network interface device 1320.

The disk drive unit 1316 includes a non-transitory computer-readable medium 1322, on which is stored one or more sets of instructions and data structures (e.g., instructions 1324) embodying or utilized by any one or more of the methodologies or functions described herein. The instructions 1324 may also reside, completely or at least partially, within the main memory 1304 and/or within the processors 1302 during execution thereof by the computer system 1300. The main memory 1304 and the processors 1302 may also constitute machine-readable media.

The instructions 1324 may further be transmitted or received over a network 1326 via the network interface device 1320 utilizing any one of a number of well-known transfer protocols (e.g., Hyper Text Transfer Protocol (HTTP)).

While the non-transitory computer-readable medium 1322 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, methods and systems for collecting and sorting garbage are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A method for collecting and sorting garbage, the method comprising:
receiving, by a processing unit, from a user device associated with a user, an identifier associated with a garbage collection bin, the user device being associated with user data;
sensing, by a sensing unit associated with the garbage collection bin, garbage collection data associated with the garbage collection bin, the garbage collection data including at least data concerning placing a garbage item into the garbage collection bin by the user;
collecting, by the processing unit, from the sensing unit, the garbage collection data;
based on the identifier, the user data, and the garbage collection data, assigning, by the processing unit, a reward to the user for placing the garbage item into the garbage collection bin; and
storing, by the processing unit, the user data and data concerning the reward to a blockchain node.

2. The method of claim 1, wherein the identifier is scannable by the user device, the identifier being placed on the garbage collection bin.

3. The method of claim 2, wherein the identifier includes a barcode.

4. The method of claim 1, wherein the garbage collection data further includes a garbage fill level, ferrous material proximity data, non-ferrous material proximity data, and a status of the garbage collection bin.

5. The method of claim 4, further comprising:
based on the garbage collection data, providing a report, by the processing unit, to a garbage managing party, the report including one or more of the following: an instruction to empty the garbage collection bin, a report on types of garbage items placed in the garbage collection bin, and a report on the status of the garbage collection bin.

6. The method of claim 1, further comprising:
detecting, by the sensing unit, a tag placed on a further garbage item present in the garbage collection bin;
scanning, by the sensing unit, the tag;
receiving, by the processing unit, tag data associated with the tag from the sensing unit, the tag data being retrieved from the tag based on the scanning;
determining, by the processing unit, that the tag data are associated with the user data, wherein the tag is preliminarily provided to the user to be placed on garbage items;
ascertaining, by the processing unit, that the further garbage item is placed to the garbage collection bin by the user; and
based on the ascertaining, assigning a further reward to the user.

7. The method of claim 6, wherein the tag includes one or more of the following: a barcode label, a Radio-Frequency Identification (RFID) tag, and a smart label.

8. The method of claim 1, further comprising:
verifying, by the sensing unit, compliance of the garbage item placed into the garbage collection bin with predetermined criteria, wherein the garbage collection data transmitted by the sensing unit to the processing unit further includes data concerning compliance of the garbage item.

9. The method of claim 1, wherein the assigning the reward includes providing cryptocurrency to a wallet of the user.

10. The method of claim 9, further comprising:
receiving, from the user device, a request to redeem the reward; and
based on the request, providing one or more services or one or more products to the user in exchange for the cryptocurrency.

11. A system for collecting and sorting garbage, the system comprising:
a processing unit configured to:
receive, from a user device associated with a user, an identifier associated with a garbage collection bin, the user device being associated with user data;
collect, from a sensing unit associated with the garbage collection bin, the garbage collection data;
based on the identifier, the user data, and the garbage collection data, assign a reward to the user for placing the garbage item into the garbage collection bin;
the sensing unit associated with the garbage collection bin, the sensing unit being configured to sense the garbage collection data associated with the garbage collection bin, the garbage collection data including at least data concerning placing a garbage item into the garbage collection bin by the user; and
a blockchain node configured to store the user data and data concerning the reward.

12. The method of claim 11, wherein the sensing unit associated with the garbage collection bin comprises:
one or more sensors to sense the garbage collection data;
a microcontroller in communication with the one or more sensors, the microcontroller being configured to transmit the garbage collection data to the processing unit via a transmission circuit; and
a power source in communication with the one or more sensors and the microcontroller.

13. The system of claim 12, wherein the one or more sensors include one or more of the following: a garbage fill level sensor, a material proximity sensor, a status light-emitting diode, and a camera.

14. The system of claim 11, wherein the identifier is scannable by the user device from the garbage collection bin.

15. The system of claim 11, wherein the processing unit is further configured to:
based on the garbage collection data, provide a report to a garbage managing party, the report including one or more of the following: an instruction to empty the garbage collection bin, a report on types of items placed in the garbage collection bin, and a report on a status of the garbage collection bin.

16. The system of claim 11, wherein the sensing unit is further configured to:
detect a tag placed on a further garbage item present in the garbage collection bin;
scan the tag; and
wherein the processing unit is further configured to:
receive tag data associated with the tag, the tag data being retrieved from the tag based on the scanning;
determine that the tag data are associated with the user data;
ascertain that the further garbage item is placed in the garbage collection bin by the user; and
based on the ascertaining, assign a further reward to the user.

17. The system of claim 16, wherein the tag includes one or more of the following: a barcode label, a Radio-Frequency Identification (RFID) tag, and a smart label.

18. The system of claim 11, wherein the sensing unit is further configured to verify compliance of the garbage item placed into the garbage collection bin with predetermined criteria, wherein the garbage collection data transmitted by the sensing unit to the processing unit further includes data concerning compliance of the garbage item.

19. The system of claim 11, wherein the assigning the reward includes providing cryptocurrency to a wallet of the user.

20. A system for collecting and sorting garbage, the system comprising:
a processing unit configured to:
receive, from a user device associated with a user, an identifier associated with a garbage collection bin, the user device being associated with user data;
collect, from a sensing unit associated with the garbage collection bin, garbage collection data; and
based on the identifier, the user data, and the garbage collection data, assign a reward to the user for placing the garbage item into the garbage collection bin;
the sensing unit associated with the garbage collection bin, the sensing unit being configured to sense the garbage collection data associated with the garbage collection bin, the garbage collection data including at least data on placing a garbage item into the garbage collection bin by the user, wherein the sensing unit associated with the garbage collection bin comprises:
one or more sensors to sense the garbage collection data;
a microcontroller in communication with the one or more sensors, the microcontroller being configured to transmit the garbage collection data to the processing unit via a transmission circuit; and
a power source in communication with the one or more sensors and the microcontroller; and
a blockchain node configured to store the user data and data on the reward.
